(19) United States
(12) Patent Application Publication
(10) Pub. No.: US 2025/0375983 A1
(43) Pub. Date: Dec. 11, 2025

(54) NON-PNEUMATIC TIRE HAVING INTERLOCKED SPOKES

(71) Applicant: The Goodyear Tire & Rubber Company, Akron, OH (US)

(72) Inventors: Daniel Paul Luc Marie Hinque, Colmar-Berg (LU); Christophe Jean Alexis Ghislain Pierre, Colmar-Berg (LU); Francesco Sportelli, Colmar-Berg (LU); Arnaud Fabrice Jean Martin, Colmar-Berg (LU); Louison Marc Liénard, Colmar-Berg (LU); George Jim Papakonstantopoulos, Akron, OH (US)

(21) Appl. No.: 18/734,349

(22) Filed: Jun. 5, 2024

(51) Int. Cl. B60C 7/14

(52) U.S. Cl. CPC B60C 7/146

(57) ABSTRACT

The invention is directed to a non-pneumatic tire comprising a circumferential supporting structure comprising a radially inner annular portion, a radially outer annular portion, and a plurality of spokes extending between the annular portions along a circumferential direction. Each spoke has two radially opposite end portions comprising a radially inner end portion and a radially outer end portion wherein at least one of the end portions comprises an axially extending anchoring portion. Furthermore, at least one of the annular portions comprises anchoring slots extending along an axial direction of the tire and adapted to axially receive and mechanically interlock anchoring portions of the spokes, wherein the portion comprising the plurality of anchoring slots comprises a plurality of axially extending elastomer composition strips. Each anchoring slot is at least partially delimited by one or more of the elastomer composition strips of the plurality of elastomer composition strips.

### FIELD OF THE INVENTION

The present invention is directed to a non-pneumatic tire comprising a supporting structure, particularly comprising a plurality of spokes, such as elastomer composition spokes.

### BACKGROUND OF THE INVENTION

Some modern non-pneumatic tires comprise a circumferential tread band and a circumferential hub portion connected with each other by a supporting structure comprising a plurality of spokes. While such non-pneumatic tires are puncture resistant compared to conventional pneumatic tires, it can be a challenge to manufacture such non-pneumatic tires in a cost-efficient manner and/or in mass production. Furthermore, it can be difficult to repair the supporting structure of such tires if damaged during use. While progress has been made in the development of non-pneumatic tires over the past years, significant room for improvement remains.

### SUMMARY OF THE INVENTION

In a first aspect, the present invention is directed to a non-pneumatic tire comprising a circumferential supporting structure comprising a radially inner annular portion, a radially outer annular portion, and a plurality of spokes extending between the radially inner annular portion and the radially outer annular portion along a circumferential direction of the tire. Each spoke of the plurality of spokes has two radially opposite end portions comprising a radially inner end portion and a radially outer end portion wherein at least one of the end portions comprises an axially extending anchoring portion. Furthermore, at least one of the radially inner annular portion and the radially outer annular portion comprises a plurality of anchoring slots extending along an axial direction of the tire and adapted to axially receive and mechanically interlock anchoring portions of the spokes against movement in a radial direction. Still in accordance with the first aspect, said portion comprising the plurality of anchoring slots comprises a plurality of axially extending elastomer composition strips, wherein each anchoring slot of the plurality of anchoring slots is at least partially delimited by one or more of the elastomer composition strips of the plurality of elastomer composition strips.

In a second aspect, the present invention is directed to a non-pneumatic tire comprising a circumferential tread band and a circumferential supporting structure, wherein the supporting structure comprises a radially outer annular portion adjacent the tread band, a radially inner annular portion, and a plurality of spokes extending between the radially inner annular portion and the radially outer annular portion along a circumferential direction of the tire. Each spoke of the plurality of spokes has two radially opposite end portions comprising a radially inner end portion and a radially outer end portion, wherein at least the radially outer end portion comprises an axially extending anchoring portion, and wherein at least the radially outer annular portion comprises a plurality of anchoring slots, extending along an axial direction of the tire, and which are adapted to axially receive and mechanically interlock anchoring portions of the spokes against movement in a radial direction. Furthermore, the radially outer annular portion comprises a plurality of elastomer composition strips extending in an axial direction of the tire, wherein each anchoring slot of the plurality of anchoring slots is at least partially delimited by one or more elastomer composition strips of the plurality of elastomer composition strips. Still in accordance with the second aspect, each of the elastomer composition strips, delimiting at least partially one of the anchoring slots, comprises an undercut surface forming at least one circumferential side of the one of the anchoring slots.

### BRIEF DESCRIPTION OF THE DRAWINGS

The invention will be described by way of example and with reference to the accompanying drawings in which:

FIG. 1 is a schematic perspective view of a non-pneumatic tire in accordance with an embodiment of the present invention;

FIG. 2 is a schematic partial cross-section of the tire shown in FIG. 1;

FIG. 3 is a schematic partial perspective view of the tread band and an adjacent part of a supporting structure already shown in FIG. 2;

FIG. 4 is a partial cross-section of C-shaped rubber composition strips adjacent a tread band, wherein each of the strips forms one anchoring slot, in accordance with an embodiment of the present invention;

FIG. 5 is a partial cross-section of metal clad rubber composition strips adjacent a tread band in accordance with another embodiment of the present invention;

FIG. 6 is a partial cross-section of rubber composition strips, comprising dovetail shaped anchoring slots, which are adjacent a tread band in accordance with an embodiment of the present invention;

FIG. 7 is a partial cross-section of rubber composition strips with stepped anchoring slots, provided on a radially inner side of a tread band, also in accordance with another embodiment of the present invention;

FIG. 8 is a partial cross-section of a tread band carrying, on its radially inner surface, a circumferential rubber composition sheet which carries, on its radially inner surface, essentially T-shaped rubber composition strips forming two adjacent sides of two circumferentially adjacent anchoring slots, all in accordance with yet another embodiment of the present invention;

FIG. 9 is a partial cross-section of a tread band, a circumferential rubber composition sheet, and a plurality of L-shaped rubber composition strips, in accordance with still another embodiment of the present invention;

FIG. 10 is a partial cross-section of a tread band, a circumferential rubber composition sheet carrying T-shaped rubber composition strips and C-shaped metal profiles, again in accordance with still another embodiment of the present invention;

FIG. 11 is a partial cross-section of a tread band carrying a circumferential rubber composition sheet and stepped rubber composition strips at least partially clad with metal, which is in accordance with still another embodiment of the present invention; and

FIG. 12 is a partial cross-section of a tread band and stepped rubber composition strips at least partially clad with metal, in accordance with still another embodiment of the present invention.

### DETAILED DESCRIPTION OF THE INVENTION

According to the first aspect, a non-pneumatic tire comprises a circumferential supporting structure comprising a radially inner annular portion, a radially outer annular portion, and a plurality of spokes extending between the radially inner annular portion and the radially outer annular portion along a circumferential direction of the tire. Each spoke of the plurality of spokes has two radially opposite end portions comprising a radially inner end portion and a radially outer end portion wherein at least one of the end portions comprises an axially extending anchoring portion. Furthermore, at least one of the radially inner annular portion and the radially outer annular portion comprises a plurality of anchoring slots extending along an axial direction of the tire and adapted to axially receive and mechanically interlock anchoring portions of the spokes against movement in a radial direction. Still in accordance with the first aspect, the portion (selected from the radially inner annular portion and the radially outer annular portion) comprising the plurality of anchoring slots comprises a plurality of axially extending elastomer composition strips, wherein each anchoring slot of the plurality of anchoring slots is at least partially delimited by one or more of the elastomer composition strips of the plurality of elastomer composition strips.

The provision of a plurality of axially extending elastomer composition strips allows a flexible and easy assembly of the non-pneumatic tire. For instance, different tire sizes and/or diameters can be built by providing a suitable number of circumferentially neighboring elastomer composition strips. Also, the number of anchoring slots can be easily varied by providing a corresponding number of elastomer composition strips. Moreover, each anchoring slot may be efficiently formed by one or more of the strips (such as one or two strips), which may, e.g., be extruded to form the anchoring slots.

In one embodiment, each anchoring slot is formed by one elastomer composition strip of the plurality of elastomer composition strips. For instance, the shape of each anchoring slot can be defined or provided by one elastomer composition strip, such as an extruded elastomer composition strip, e.g., at least partially enclosing a cavity defining the cross-section of the anchoring slot (e.g., perpendicular to the axial direction of the tire or, in other words, parallel to the equatorial plane of the tire). Moreover, tires with different diameters can be provided by providing a desired number of circumferentially neighboring elastomer composition strips.

In another embodiment, each elastomer composition strip has circumferentially opposite and undercut surfaces forming the anchoring slot. Such shapes help to anchor a spoke held in an anchoring slot against movement in a radial direction and/or radially out of the anchoring slot.

In another embodiment, the elastomer composition strips forming the anchoring slots and/or the anchoring slots comprise one or more of following cross-sections: a T-shaped cross-section, a dovetail-shaped cross-section, and a radially stepped cross-section. In other words, an anchoring slot may have one of the mentioned cross-sections (in a plane perpendicular to the axial direction). Optionally, some anchoring slots have one of said cross-sections and other anchoring slots have another one of said cross-sections.

In still another embodiment, one or more of the anchoring slots are one or more of at least partially clad by metal and comprising axially extending metal profiles having one or more of said cross-sections. In such an embodiment, the metal helps to provide an even more robust anchoring slot.

In still another embodiment, the elastomer composition strips comprise elastomer composition strips forming at least a portion of one circumferential side of a circumferentially adjacent anchoring slot. Thus, it is possible that one elastomer composition strip forms only one circumferential side or half of an anchoring slot but not a whole anchoring slot. Moreover, it is possible that one strip forms one side or half of two circumferentially neighboring anchoring slots. Such an embodiment again allows a flexible and/or efficient manufacturing of a non-pneumatic tire.

In still another embodiment, each of the elastomer composition strips, forming at least a portion of one circumferential side of a circumferentially adjacent anchoring slot, has an undercut surface forming the circumferential side (or circumferential neighboring side) of the circumferentially adjacent anchoring slot.

In still another embodiment, the undercut surface is stepped or sloped.

In still another embodiment, the undercut surface is one or more of: at least partially clad by metal and carrying an axially extending metal profile.

In still another embodiment, the non-pneumatic tire further comprises a circumferentially extending elastomer composition sheet which forms (preferably radially outer, or radially outermost) bottoms of the anchoring slots. The circumferentially extending elastomer composition sheet preferably extends over at least a third, at least a half, or at least 90%, or over an entirety of the circumference. Thus, the elastomer composition sheet forms bottoms of multiple grooves, or, e.g., the bottoms of all grooves in case it extends over the whole circumference. Said sheet may also be described as a band extending in the circumferential and axial directions and/or having a thickness in the radial direction.

In still another embodiment, the preferably radially outer bottoms of the anchoring slots are formed by one or more further elastomer composition strips of the portion.

In still another embodiment, one (or each) elastomer composition strip of the elastomer composition strips forms one circumferentially neighboring side of two adjacent or circumferentially neighboring anchoring slots. In other words, one strip forms one circumferentially adjacent side per circumferentially neighboring anchoring slot, wherein the strip has two circumferentially neighboring anchoring slots.

In still another embodiment, said one elastomer composition strip has a cross-section forming an undercut surface of each circumferentially neighboring sidewall of the two circumferentially neighboring anchoring slots.

In still another embodiment, said one elastomer composition strip has one of the following cross-sections to form one sidewall of its circumferentially neighboring anchoring slots: a T-shaped cross-section, a stepped cross-section, and a triangular-shaped cross-section.

In still another embodiment, the elastomer composition strip is at least partially clad with metal to form at least a portion of each neighboring sidewall of the circumferentially neighboring anchoring slots.

In still another embodiment, each of the elastomer composition strips has one or more of an axial length of at least 40% (preferably at least 70%) of the maximum axial width of the non-pneumatic tire; an axial length within the range of 8 cm to 30 cm; a maximum circumferential width within a range of 1 cm to 4 cm (preferably 1 cm to 3 cm); an aspect ratio of axial length to maximum circumferential width within a range of 4 : 1 to 20 : 1; a maximum radial height within a range of 0.5 cm to 3 cm (preferably 1 cm to 2.5 cm); and a radial height which is at most three times (preferably at most 2 times the maximum circumferential width).

In still another embodiment, said elastomer composition sheet has one or more of an axial extension of at least 40% (preferably at least 70%) of the maximum axial width of the non-pneumatic tire; an axial extension of at least 20 cm; and a maximum radial thickness within a range of 0.2 cm to 2 cm.

In still another embodiment, the anchoring slots taper along the axial direction, and, optionally, corresponding anchoring portions taper with a shape complementary to the tapering anchoring slot.

In still another embodiment, every second anchoring slot, along the circumferential direction, has an oppositely oriented taper, along the axial direction.

In still another embodiment, the anchoring slots are formed on a radially inner side or surface of the radially outer annular portion.

In still another embodiment, the tire further comprises a radially outermost circumferential tread band. Optionally, the tread band comprises a circumferential radially outer tread portion and a (radially inner) circumferential shearband arranged radially between the tread portion and the radially outer annular portion of the supporting structure. While not explicitly depicted herein, the circumferential tread portion may comprise a plurality of tread grooves, such as circumferential tread grooves and/or lateral tread grooves. It may also comprise a plurality of circumferential tread layers, such as a base tread layer, and one or more tread cap layers. Such layers may comprise one or more rubber compositions. In another embodiment, the circumferential shearband comprises multiple stacked circumferential layers. Shearbands as such are known in the art of non-pneumatic tires and are not within the main focus of the present invention. Optionally, the shearband has from 4 to 20 elastomer composition layers, typically comprising multiple non-cord reinforced rubber composition layers and multiple cord reinforced rubber composition layers. For instance, cord reinforced rubber composition layers may comprise textile cords and/or metal cords, such as steel cords, as known in the art.

In still another embodiment, the elastomer composition is an uncured and/or precured elastomer composition. In other words, the elastomer composition strips are optionally uncured and/or precured elastomer composition strips.

In still another embodiment, the elastomer composition is a rubber composition, such as a sulfur curable elastomer composition.

In still another embodiment, multiple components and/or portions, such as comprising one or more of a tread band, a tread portion, a shearband, a radially outer annular portion, a radially inner annular portion, a circumferential elastomer/rubber composition sheet, strips, and optionally spokes, may be one of co-cured together, cured together, and adhered to one another via one or more adhesives. For instance, it is possible to attach multiple components, members or portions comprising precured and/or cured elastomer or rubber compositions together and co-cure them. Preferably, they are sulfur cured to each other. Additionally, or alternatively, uncured rubber, primers or dips (such as RFL-based) and/or adhesives can be used to improve connection between such components, members or portions. Suitable adhesives are also commercially available and known to the person skilled in the art. They can be chosen in view of the components and/or compositions to be attached to each other. For instance, adhesives include one or more of rubber based, silicone based, isocyanate based, acrylate based, epoxide based, and polyurethane based adhesives.

Optionally, a curing cement, such as used for retreading tires, can be used to co-cure elastomer composition portions to already cured elastomer composition portions. The use of a green rubber layer is also possible for co-curing. Optionally, one or more functional polymers may be used in one or more of the elastomer compositions and which support co-curing. Such functional groups may comprise but are not limited to one or more of isocyanate, hydroxide, halogenide, amine, amide, carboxylic, epoxide, acrylate, peroxide, and other suitable groups.

In another preferred embodiment, said elastomer composition (such as the rubber composition) comprises one or more of rubber (such as comprising one or more of natural rubber, synthetic polyisoprene, butadiene rubber, styrene-butadiene rubber, and butyl rubber), a filler (such as comprising one or more of carbon black and silica), resin (such as a hydrocarbon resin selected from one or more of coumarone-indene resins, petroleum hydrocarbon resins, terpene resins, styrene/alphamethylstyrene resins, terpene phenol resins, rosin derived resins and copolymers and/or mixtures thereof), accelerators, antidegradants, oils, liquid diene-based polymers, coupling agents (such as carbon black coupling agents and/or silanes), sulfur donors, and sulfur. Liquid means herein that a material is in a liquid state at 23°C. Optionally, elastomer compositions, such as rubber compositions, may be fiber-reinforced.

In still another embodiment, the elastomer composition, or rubber composition, comprises 100 phr of rubber comprising one or more of natural rubber, synthetic polyisoprene, polybutadiene rubber, and styrene butadiene rubber. Preferably, the composition (such as in a portion and/or spoke of the supporting structure) comprises at least 50 phr of natural rubber (such as from 50 phr to 100 phr of natural rubber, and optionally from 0 phr to 50 phr of polybutadiene rubber). Additionally, the elastomer or rubber compositions comprise a filler, preferably comprising carbon black and/or silica. For instance, such filler may be within a range of 20 phr to 150 phr, preferably within a range of 30 phr to 90 phr. Preferably, such a filler comprises predominantly carbon black. The elastomer or rubber composition may further comprise from 1 phr to 40 phr of resin, preferably including a phenolic resin. Moreover, the elastomer or rubber composition may comprise from 1 phr to 30 phr of oil, preferably from 1 phr to 20 phr of oil. Finally, the elastomer or rubber composition may typically comprise from 1 phr to 15 phr of antidegradant(s), from 0.5 phr to 10 phr of accelerator(s), from 0.1 phr to 10 phr of zinc oxide, and from 0.5 phr to 10 phr of sulfur. Further ingredients may also be present.

In still another embodiment, the spokes are cord and/or fiber-reinforced, wherein one or more cords and/or fibers optionally comprise one of textile, carbon, metal, bio-based, polymer, and glass fiber material.

In still another embodiment, cords and/or fibers comprise a textile material, optionally selected from one or more of polyester (preferably, PET), polyamide (preferably, one or more of PA-6, PA-6,6, e.g., Nylon^{TM}, aromatic polyamide / aramid), and rayon. Optionally, one or more of these materials may be recycled materials. Using hybrid materials or cords and/or fibers of multiple such materials is also an option.

In another embodiment, cords provided herein are one or more of single filament cords and multifilament cords. For instance, cords may have (maximum) diameters measured perpendicularly to the extension of the cord within a range of 0.01 mm to 2 mm, preferably within a range of 0.01 mm and 1 mm, measured after extraction from the tire.

In still another embodiment, the elastomer composition strips contact, or directly contact, each other side by side in the circumferential direction. Such a feature helps to provide an even more robust supporting structure.

According to the second aspect, the non-pneumatic tire comprises a circumferential tread band and a circumferential supporting structure, wherein the supporting structure comprises a radially outer annular portion adjacent the tread band (which preferably comprises a radially inner shearband and a radially outer tread), a radially inner annular portion, and a plurality of spokes extending between the radially inner annular portion and the radially outer annular portion along a circumferential direction of the tire. Each spoke of the plurality of spokes has two radially opposite end portions comprising a radially inner end portion and a radially outer end portion, wherein at least the radially outer end portion comprises an axially extending anchoring portion, and wherein at least the radially outer annular portion comprises a plurality of anchoring slots, extending along an axial direction of the tire, which are adapted to axially receive and mechanically interlock anchoring portions of the spokes against movement in a radial direction. Furthermore, the radially outer annular portion comprises a plurality of elastomer composition strips extending in an axial direction of the tire, wherein each anchoring slot of the plurality of anchoring slots is at least partially delimited by one or more elastomer composition strips of the plurality of elastomer composition strips. Still in accordance with the second aspect, each of the elastomer composition strips, delimiting at least partially one of the anchoring slots, comprises an undercut surface forming at least one circumferential side of the one of the anchoring slots.

It is emphasized that all aspects of the invention, their embodiments and/or features thereof may be combined with one another. In particular, embodiments of the first aspect are also intended to be embodiments of the second aspect, and vice versa.

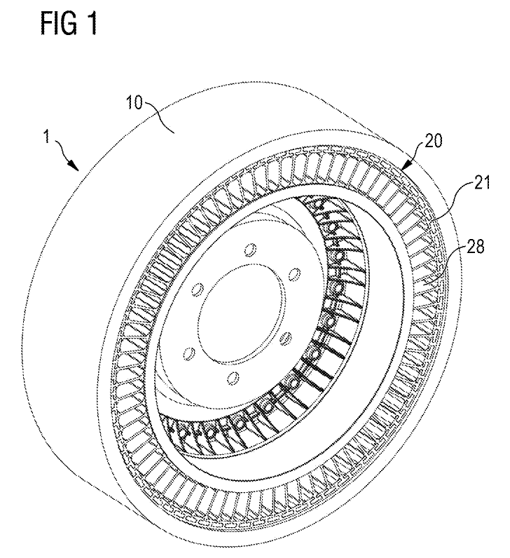

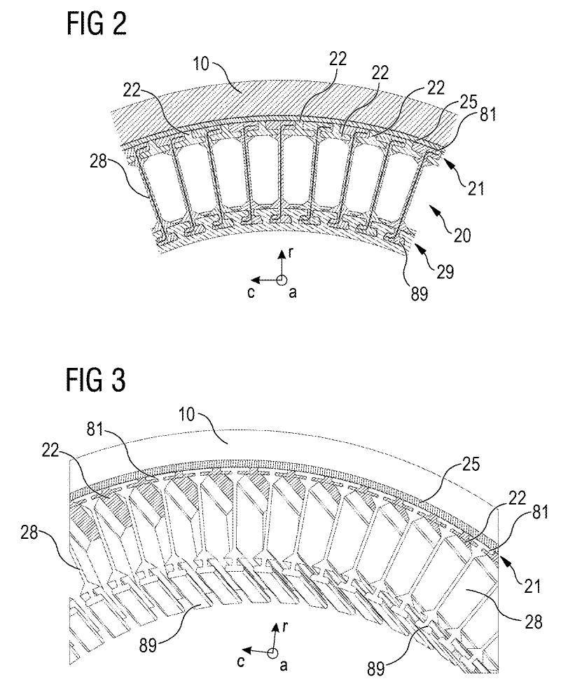

FIG. 1 shows a schematic perspective view of a non-pneumatic tire 1 according to the present invention which comprises a circumferential tread band 10 and a circumferential supporting structure 20. The tread band 10 preferably comprises a radially outer circumferential tread or tread portion and a radially inner circumferential shearband, which are not explicitly depicted in FIG. 1. The supporting structure 20 comprises a radially outer annular portion 21 and a radially inner annular portion (shown in further details in FIG. 2), and a plurality of spokes 28, preferably cord reinforced rubber composition spokes 28, extending between both annular portions. The radially outer annular portion 21 comprises a plurality of axially extending rubber composition strips which are shown in further detail in the schematic and magnified partial cross-section according to FIG. 2 and the schematic partial perspective view according to FIG. 3.

As visible in FIG. 2, each of the spokes 28 of the supporting structure 20 comprises a radially inner anchoring portion 89 and a radially outer anchoring portion 81, which are mechanically interlocked in corresponding anchoring slots in the respective radially inner annular portion 29 and the radially outer annular portion 21. In accordance with the present embodiment, the radially outer annular portion 21 comprises a plurality of axially extending rubber composition strips 22. These rubber composition strips 22 are in contact with a circumferential rubber composition band or rubber composition sheet 25 which is radially adjacent the tread band 10 along the circumferential direction. Two circumferentially neighboring rubber composition strips 22 form an anchoring slot for receiving a complementary anchoring portion 81 of a spoke 28. The radially outer bottom of each anchoring slot in the radially outer annular portion 21 is formed by the circumferential rubber composition sheet 25. In particular, the anchoring portions 81, 89 of the spokes 28 are axially insertable into corresponding anchoring slots. The circumferentially neighboring rubber strips 22, having in the present embodiment T-shapes, form an axially extending slot with undercut side surfaces. Thus, a spoke 28 inserted with its anchoring portion 81 into such a slot is held against movement in a radial direction by mechanical interlocking. In an option, the spokes 28 are only held by mechanical interlocking and, e.g., friction of the rubber material. In another option, the spokes may additionally be co-cured or glued together with the radially outer annular portion 21.

In multiple embodiments and/or Figures herein, the circumferential direction c, the axial direction a, and the radial direction r, are indicated for better orientation. The circumferential direction c is perpendicular to the axial direction a. The same applies to the radial direction r. The axial direction a is parallel to the axis of rotation of the tire. Such directions mentioned herein are not necessarily limited to a specific orientation of the given direction, unless described otherwise herein.

In an embodiment, one or more components and/or portions mentioned herein, such as the tread band 10, the circumferential rubber composition sheet 25, the rubber composition strips 22, the rubber composition spokes 28, and the radially inner annular portion may be assembled in an uncured or precured state. Preferably, the rubber composition strips 22 are extruded rubber composition strips 22. In other words, they can be extruded with the desired cross-section (perpendicular to the length of the strip) and can optionally be cut to a desired length and mounted to the tread band 10 (or the shearband), and/or the circumferential sheet 25 respectively.

As also shown in FIG. 2, it is possible that an inner annular portion 29 of the tire 1 comprises a circumferential band which comprises a plurality of axially extending anchoring slots for receiving corresponding, or in other words, complementarily shaped anchoring portions 89 of the spokes 28.

The schematic partial perspective view of FIG. 3 further visualizes the axial extension of the spokes 28 and the axial extension of the T-shaped rubber composition strips 22. FIG. 3 uses reference signs as already mentioned in relation to FIG. 2, indicating the tread band 10, the anchoring portions 81, 89, and the circumferential rubber composition sheet 25.

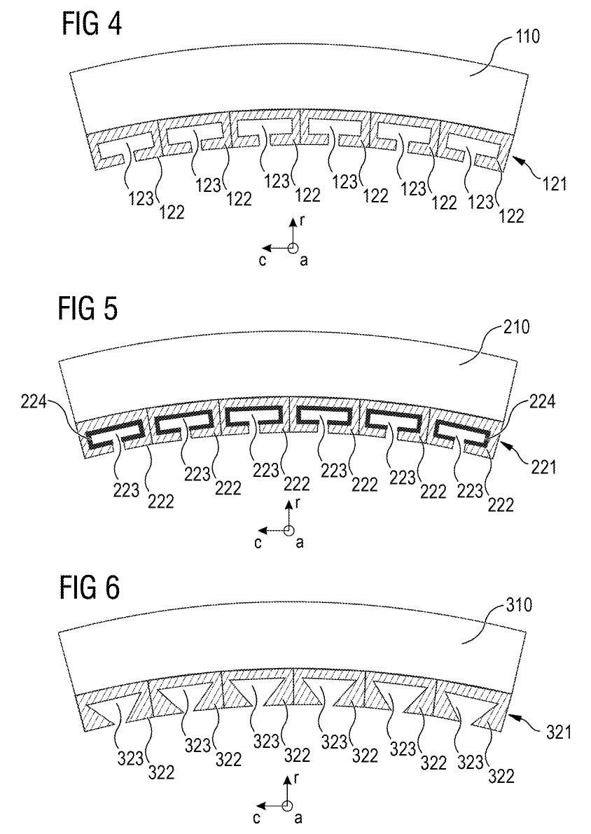

FIGS. 4 to 12 show multiple further embodiments of radially outer annular portions of supporting structures contacting tread bands along the circumferential direction and comprising axially extending rubber composition strips. While FIGS. 4 to 12 schematically show only circumferential segments, the respective portions of the supporting structures and/or tread bands preferably extend along the whole circumferential direction of the tire.

FIG. 4 shows a circumferential segment of a radially outer annular portion 121 of a supporting structure, comprising a plurality of circumferentially neighboring and axially extending rubber composition strips 122. The rubber composition strips 122 (directly) contact each other, preferably side by side, along the circumferential direction. Furthermore, each axially extending rubber composition strip 122 comprises an axially extending anchoring slot 123 which is formed by an essentially C-shaped cross-section of the respective rubber composition strip 122. In particular, such or similar cross-sections mentioned herein extend in a plane perpendicular to the axial direction and/or perpendicular to an elongated extension of the rubber composition strip. Thus, an anchoring slot 123 with undercut sidewalls is delimited and/or formed by the rubber composition strip 122 which is suitable to hold corresponding / complementary anchoring portions of spokes (not shown in FIG. 4). The radially outer annular portion 121 of the supporting structure extends circumferentially on a radially inner side of the circumferential tread band 110.

FIG. 5 shows a similar embodiment as FIG. 4. In addition to the design shown in FIG. 4, the axially extending rubber composition strips 222 according to FIG. 5 comprise essentially C-shaped metal profiles 224 essentially forming the anchoring slots 223. A radially outer annular portion 221 of the supporting structure, comprising such rubber composition strips 222 carrying the C-shaped metal profiles 224 may provide an even more robust interface between axially insertable spokes and the anchoring slots 223 provided radially inwards the tread band 210.

FIG. 6 schematically shows another circumferential segment of a tread band 310 and a radially outer annular portion 321 comprising, or formed by, a plurality of circumferentially neighboring and axially extending rubber composition strips 322. Each rubber composition strip 322 comprises a dovetail shaped anchoring slot 323. As in previously described embodiments, it is possible to extrude the rubber compositions strips with an appropriate die, here to obtain a dovetail shaped anchoring slot 323. As in other embodiments shown herein, a direct contact of the circumferentially neighboring rubber composition strips 322 helps to provide a particularly robust supporting structure.

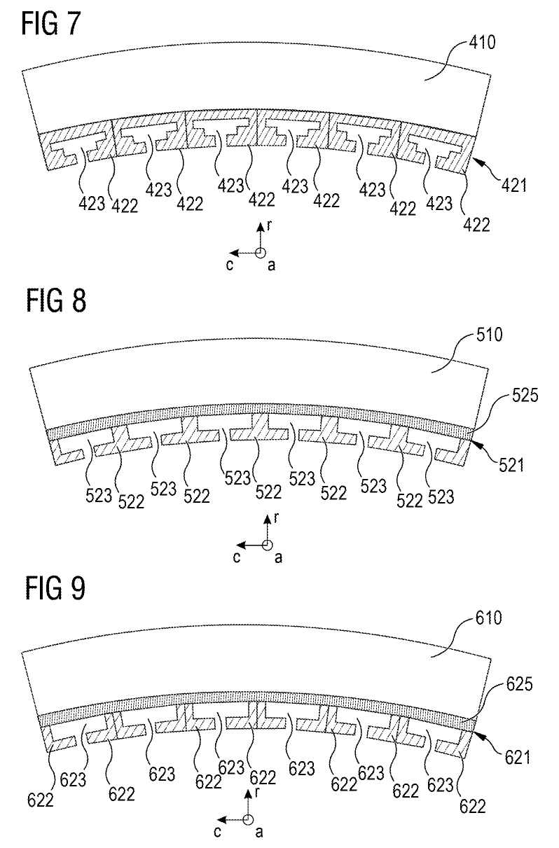

FIG. 7 shows yet another embodiment according to the present invention, in which a supporting structure of a non-pneumatic tire comprises a radially outer annular portion 421 of its supporting structure, comprising multiple circumferentially adjacent and axially extending rubber composition strips 422. In the present embodiment, each rubber composition strip 422 comprises a stepped anchoring slot 423. In other words, each rubber composition strip 422 comprises and delimits an anchoring slot 423, which is circumferentially wider at its radially outer bottom portion (on a radially outer side of the anchoring slot) and circumferentially narrower at its opening (on a radially inner side of the anchoring slot). As in previously described embodiments, the rubber composition strips 422 are arranged on a radially inner side of the tread band 410.

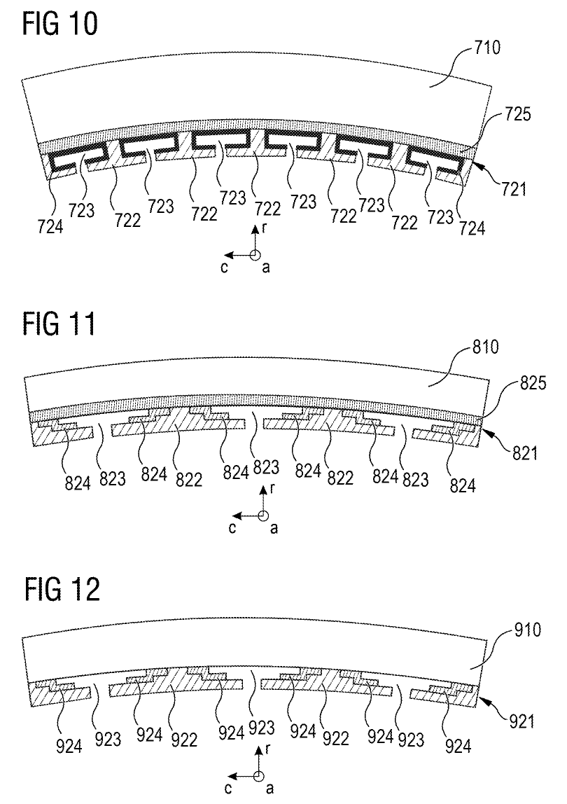

In the embodiment of FIG. 8, a radially outer annular portion 521 of a supporting structure comprises a plurality of T-shaped rubber composition strips 522 which are attached to a circumferential rubber composition sheet 525 arranged radially between the rubber composition strips 522 and a circumferential tread band 510 of the tire. Contrary to the previously described embodiments, each T-shaped rubber composition strip does not form two circumferential (or, in other words, circumferentially opposite) sides of an anchoring slot 523. The circumferential sides of each anchoring slot 523 are rather formed by two circumferentially neighboring (and circumferentially spaced apart) rubber composition strips 522, wherein each circumferential side of an anchoring slot 523 is formed by one of the two neighboring rubber composition strips 522. In the present example, the (radially outer) bottoms of the anchoring slots 523 are together formed by the circumferentially extending rubber composition sheet 525. While the present embodiment comprises the rubber composition sheet 525, it is noted that the T-shaped rubber composition strips 522 may also be attached with their foot portions directly to the tread band. The same may apply to other embodiments mentioned herein, such as the embodiments of FIG. 9 and FIG. 10. The embodiment of FIG. 8 again provides an efficient and cost-effective way to manufacture a portion of the supporting structure of a non-pneumatic tire. The rubber composition strips can be extruded at large scale and be flexibly cut to a desired length, depending on tire type and size. The number of rubber composition strips and corresponding anchoring slots can be varied as needed for different tire diameters.

In another embodiment shown in FIG. 9, a tread band 610 carries a circumferential rubber composition sheet 625 on a radially inner surface which forms the radially outer bottoms of axially extending anchoring slots 623 arranged along the circumferential direction of the radially outer annular portion 621 of a supporting structure of a non-pneumatic tire. While the embodiment of FIG. 8 comprises axially extending T-shaped rubber composition strips, the embodiment of FIG. 9 comprises L-shaped rubber composition strips 622, wherein an L-shaped rubber composition strip 622 is arranged on each side of an anchoring slot 623, forming with its undercut surface and/or shape the circumferential sidewalls of the anchoring slots 623. In other words, the L-shaped rubber composition strips 622 extend perpendicularly from a radially outer position in a radially inner orientation and then with a kink in a circumferential direction to form one circumferential (undercut) side of an anchoring slot 623. Preferably, as shown in FIG. 9, two circumferentially adjacent L-shaped rubber composition strips 622 are arranged back-to-back to form together essentially a T-shape, e.g., with a foot portion contacting the circumferential rubber composition sheet 625.

The embodiment of FIG. 10 provides a similar construction as the embodiment of FIG. 9 but with an additional cross-sectionally C-shaped metal cladding covering most of the surface forming the respective anchoring slot. Thus, the embodiment according to FIG. 10 comprises a tread band 710 radially and circumferentially attached to a circumferentially extending rubber composition sheet 725. On a radially inner side, the circumferentially extending rubber composition sheet 725 carries C-shaped metal profiles 724 extending in an axial direction and having an opening facing away from the tread band 710 in a radially inward direction. In this case, cross-sectionally T-shaped rubber composition strips 722 extend with a radially extending foot portion into a space circumferentially between the metal profiles and with a circumferentially extending head portion (with opposing circumferential orientations) towards adjacent openings of two adjacent C-shaped metal profiles 724. Such an arrangement can again be easily and/or cost-efficiently assembled. The C-shaped metal profiles 724 can be provided at various lengths and/or cut at desired lengths. Moreover, they may be applied to the tread band 710 and/or the circumferential rubber composition sheet 725 and ease mounting of the T-shaped rubber composition strips 722. Furthermore, the metal profiles 724 provide very robust anchoring slots. Another advantage of the provided C-shape of the metal consists in that only a single metal profile 724 is needed to reinforce an anchoring slot.

FIG. 11 shows still another embodiment according to the present invention, comprising a tread band 810 supported by a supporting structure comprising a radially outer annular portion 821 which comprises a circumferential rubber composition sheet 825 attached to a radially inner surface of the tread band 810, and a plurality of stepped, axially extending rubber composition strips 822 at least partially delimiting neighboring axially extending anchoring slots 823. In addition, each rubber composition strip 823 is partially clad on each of its stepped circumferential sides by a stepped metal profile 824. Thus, each anchoring slot 823 is circumferentially wider at its radially outer bottom portion compared to its width at its radially inner opening. Moreover, at least one radially outer step of the anchoring slot’s sidewall is reinforced by the metal profile 824.

FIG. 12 depicts still another embodiment, in which rubber composition strips 922 and metal profiles 924 are shaped as already described with respect to the similar embodiment of FIG. 11. Moreover, the shape of the anchoring slots 923 corresponds also to the shape already described in the previous embodiment. However, in contrast to the previously described embodiment, the embodiment of FIG. 12 is devoid of a circumferentially extending rubber composition sheet between the tread band 910 and the axially extending rubber composition strips 922.

In an embodiment, the non-pneumatic tires mentioned herein may be one of truck tires and passenger car tires. However, other vehicle types are also an option.

In summary, the present invention and/or various of its embodiments allow to provide non-pneumatic tires with connecting structures having a plurality of axially extending rubber composition strips. Such strips can be cost-efficiently manufactured, such as by extrusion. Strips with the same cross-section can be used in appropriate numbers to adapt to different tire diameters. The strips can also be easily provided with different axial lengths, just as needed in view of specifically required tire widths. Moreover, such strips may be cured or co-cured together with other tire components and/or portions which may help to avoid use of additional adhesives. Furthermore, said strips may be used to efficiently form anchoring slots, such as allowing a mechanical interlocking with corresponding anchoring portions of spokes. Preferably, the rubber composition strips allow an axial demounting of spokes inserted into anchoring slots formed and/or delimited by one or more of the strips.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A non-pneumatic tire comprising a circumferential supporting structure comprising a radially inner annular portion, a radially outer annular portion, and a plurality of spokes extending between the radially inner annular portion and the radially outer annular portion along a circumferential direction of the tire,
wherein each spoke of the plurality of spokes has two radially opposite end portions comprising a radially inner end portion and a radially outer end portion wherein at least one of the end portions comprises an axially extending anchoring portion,
wherein at least one of the radially inner annular portion and the radially outer annular portion comprises a plurality of anchoring slots extending along an axial direction of the tire and adapted to axially receive and mechanically interlock anchoring portions of the spokes against movement in a radial direction of the tire,
wherein the portion comprising the plurality of anchoring slots comprises a plurality of axially extending elastomer composition strips, and
wherein each anchoring slot of the plurality of anchoring slots is at least partially delimited by one or more of the elastomer composition strips of the plurality of elastomer composition strips.

2. The non-pneumatic tire according to claim 1, wherein each anchoring slot is formed by one elastomer composition strip of the plurality of elastomer composition strips.

3. The non-pneumatic tire according to claim 2, wherein each elastomer composition strip has circumferentially opposite and undercut surfaces forming the anchoring slot.

4. The non-pneumatic tire according to claim 3, wherein each anchoring slot formed by one elastomer composition strip has one or more of following cross-sections: a T-shaped cross-section, a dovetail-shaped cross-section, and a radially stepped cross-section.

5. The non-pneumatic tire according to claim 4, wherein one or more of the anchoring slots are one or more of: at least partially clad by metal and comprising axially extending metal profiles having one or more of said cross-sections.

6. The non-pneumatic tire according to claim 1, wherein the elastomer composition strips comprise elastomer composition strips forming at least a portion of one circumferential side of a circumferentially adjacent anchoring slot.

7. The non-pneumatic tire according to claim 6, wherein each elastomer composition strip of the elastomer composition strips, forming at least a portion of one circumferential side of a circumferentially adjacent anchoring slot, has an undercut surface forming the circumferential side of the circumferentially adjacent anchoring slot.

8. The non-pneumatic tire according to claim 7, wherein the undercut surface is stepped or sloped.

9. The non-pneumatic tire according to claim 7, wherein the undercut surface is one or more of: at least partially clad by metal and carrying an axially extending metal profile.

10. The non-pneumatic tire according to claim 7, wherein the non-pneumatic tire further comprises a circumferentially extending elastomer composition sheet which forms radially outer bottoms of the anchoring slots.

11. The non-pneumatic tire according to claim 6, wherein one elastomer composition strip of the elastomer composition strips forms two circumferentially neighboring sides of two circumferentially neighboring anchoring slots.

12. The non-pneumatic tire according to claim 11, wherein said one elastomer composition strip has a cross-section forming an undercut surface of each neighboring sidewall of the two circumferentially neighboring anchoring slots.

13. The non-pneumatic tire according to claim 12, wherein said one elastomer composition strip has one of the following cross-sections to form one sidewall of its circumferentially neighboring anchoring slots: a T-shaped cross-section, a stepped cross-section, and a triangular-shaped cross-section.

14. The non-pneumatic tire according to claim 11, wherein the elastomer composition strip is at least partially clad with metal to form at least a portion of each neighboring sidewall of the circumferentially neighboring anchoring slots.

15. The non-pneumatic tire according to claim 1, wherein each of the elastomer composition strips has one of:
an axial length of at least 40% of the maximum axial width of the non-pneumatic tire;
an axial length within the range of 8 cm to 30 cm;
a maximum circumferential width within a range of 1 cm to 4 cm;
an aspect ratio of its axial length to its maximum circumferential width within a range of 4 : 1 to 20 : 1;
a maximum radial height within a range of 0.5 cm to 3 cm; and
a radial height which is at most three times a circumferential width of the elastomer composition strip.

16. The non-pneumatic tire according to claim 10, wherein the circumferentially extending elastomer composition sheet has one of:
an axial extension of at least 40% of the maximum axial width of the non-pneumatic tire;
an axial extension of at least 20 cm; and
a maximum radial thickness within a range of 0.2 cm to 2 cm.

17. The non-pneumatic tire according to claim 1, wherein the anchoring slots are formed on a radially inner side of the radially outer annular portion.

18. The non-pneumatic tire according to claim 17, wherein the tire further comprises a radially outermost circumferential tread portion and a circumferential shearband arranged radially between the tread portion and the radially outer annular portion of the supporting structure.

19. The non-pneumatic tire according to claim 1, wherein the elastomer composition is a rubber composition.

20. A non-pneumatic tire comprising a circumferential tread band and a circumferential supporting structure,
wherein the supporting structure comprises a radially outer annular portion adjacent the tread band, a radially inner annular portion, and a plurality of spokes extending between the radially inner annular portion and the radially outer annular portion along a circumferential direction of the tire,
wherein each spoke of the plurality of spokes has two radially opposite end portions comprising a radially inner end portion and a radially outer end portion and wherein at least the radially outer end portion comprises an axially extending anchoring portion,
wherein at least the radially outer annular portion comprises a plurality of anchoring slots extending along an axial direction of the tire, which are adapted to axially receive and mechanically interlock anchoring portions of the spokes against movement in a radial direction,
wherein the radially outer annular portion comprises a plurality of elastomer composition strips extending in an axial direction of the tire,
wherein each anchoring slot of the plurality of anchoring slots is at least partially delimited by one or more elastomer composition strips of the plurality of elastomer composition strips, and
wherein each of the elastomer composition strips, delimiting at least partially one of the anchoring slots, comprises an undercut surface forming at least one circumferential side of the one of the anchoring slots.
